(19) United States
(12) Patent Application Publication
(10) Pub. No.: US 2024/0338872 A1
(43) Pub. Date: Oct. 10, 2024

(54) Method for Providing a Sign-Language Avatar Video for a Primary Video

(71) Applicant: Vimeo.com, Inc., New York, NY (US)

(72) Inventor: Vittorio GIOVARA, New York, NY (US)

(73) Assignee: Vimeo.com, Inc., New York, NY (US)

(21) Appl. No.: 18/627,979

(22) Filed: Apr. 5, 2024

Related U.S. Application Data
(60) Provisional application No. 63/494,560, filed on Apr. 6, 2023.
(60) Provisional application No. 63/591,918, filed on Oct. 20, 2023.

(51) Int. Cl. G06T 13/20; G06F 40/58; G06T 13/40; G06T 15/00; G10L 15/26

(52) U.S. Cl. CPC G06T 13/205; G06F 40/58; G06T 13/40; G06T 15/005; G10L 15/26; G06T 2210/52

(57) ABSTRACT

An embodiment provides a software system capable of reading an audio file or a transcript and converting it into a sequence of sign language movements. A 3D or 2D avatar animation may be generated from the sequence of sign language movements in a primary window or in a secondary window on a user's computing device (or in a virtual reality or augmented reality space) using accelerated graphical APIs To make movements appear more natural, the sequence of gestures/movements may be generated through an AI model, or a combination of natural language analysis and an AI model, to smooth out any possible transition across the gestures and adapt it to the viewing condition.

### CROSS-REFERENCE TO RELATED APPLICATION

This application claims benefit of U.S. provisional Application Ser. No. 63/494,560, filed Apr. 6, 2023, and U.S. provisional Ser. No. 63/591,918 filed Oct. 20, 2023, the entire disclosures of which are incorporated herein by reference.

### BACKGROUND

The current disclosure relates to video display and video streaming technologies. There is a need in the art for a method and/or mechanism to improve accessibility to video display and video streaming for those that need or desire to communicate using sign language.

### SUMMARY

Embodiments of the disclosure provide an accessibility implementation that displays a 3D (or 2D) model (or avatar) alongside or embedded within a video player window display. This avatar is used to replicate a previously translated text or audio into sign language, using an AI model to refine the necessary movements.

In a first aspect, a method for providing sign-language avatar video for a primary video includes: providing a video and a transcription of spoken audio from the video; converting the transcription into a sequence of sign language gesture and/or movement instructions; transmitting the video and gesture/movement instructions to a user's computing device; displaying the video by the user's computing device in a primary video window; generating an avatar animation from the gesture/movement instructions in the primary window or in a secondary window by the user's computing device using accelerated graphical APIs (such as browser canvas APIs, WebGL calls, Vulkan surfaces, DirectX or Metal GPU access).

In an embodiment, the sequence of sign language gesture and/or movement instructions is generated by an AI model; and/or the sequence of sign language gesture and/or movement instructions is generated by static conversion or translation. Alternatively, or in addition, the avatar animation is on a 3D humanoid model.

Alternatively, or in addition, the avatar used in the avatar animation is customizable on the user's computing device and/or on the creator's configuration options. In a further detailed embodiment, the computing device provides the user with a selection of available avatars from which to select from.

Alternatively, or in addition, the animation format for the avatar is based on a list of qualifying properties that describe a 3D scene and a humanoid avatar, including textures, meshes, materials, expressions, and armature (such as described in the VRM file format).

In a second aspect, a method for providing a sign-language avatar video for a primary video, includes: receiving on a user's computing device a primary video and secondary sign-language gesture/movement instructions associated with spoken audio in the primary video; displaying the primary video on the user's computing device in a primary video window; and generating an avatar animation from the gesture/movement instructions in either the primary video window or in a secondary window on the user's computing device using GPU processing calls (such as WebGL calls or other similar browser APIs or low energy rendering Vulkan surface or equivalent).

In a third aspect, a method for providing a sign-language avatar in a display includes: receiving on a user's computing device or system an audio input; converting speech in the audio input into a transcription of speech; converting the transcription into a sequence of sign language gesture and/or movement instructions; and generating an animation from the gesture/movement instructions in a display portion of the user's computing device. In a more detailed embodiment, the animation is generated using accelerated graphical APIs (such as browser canvas APIs, WebGL calls, Vulkan surfaces, DirectX or Metal GPU access). Alternatively, or in addition, the sequence of sign language gesture and/or movement instructions is generated by an AI model; and/or the sequence of sign language gesture and/or movement instructions is generated by static conversion or translation. Alternatively, or in addition, the animation is a 3D humanoid model. Alternatively, or in addition, the animation is a 2D humanoid model. Alternatively, or in addition, the animation is an avatar animation, which is customizable on the user's computing device and/or on the creator's configuration options. Alternatively, or in addition, the computing device or system provides the user with a selection of available avatars from which to select from. Alternatively, or in addition, the audio input is extracted from a video input.

Alternatively, or in addition, the animation format is based on a list of qualifying properties that describe a scene and a humanoid avatar, including textures, meshes, materials, expressions, and armature (such as described in the VRM file format). Alternatively, or in addition, the steps occur in real time or near real time. Alternatively, or in addition, the computing device or system comprises an augmented reality device. Alternatively, or in addition, the computing device or system comprises a virtual reality device.

In a fourth aspect, a non-transitory memory device is provided that includes computer instructions for controlling one or more computer processors to perform the steps of any of the methods disclosed herein.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a flow diagram representation of various embodiments disclosed herein;

FIG. 2 is a graphical illustration of a display of a computing device according to various embodiments disclosed herein;

FIG. 3 is an illustration of an augmented reality computing device utilizing various embodiments disclosed herein;

FIG. 4 is an illustration of a virtual reality computing device utilizing various embodiments disclosed herein; and

FIG. 5 is a block diagram representation of a system for implementing various embodiments disclosed herein.

### DETAILED DESCRIPTION

Embodiments of the disclosure provide an accessibility implementation that displays a 3D model (or avatar) alongside a video player. This avatar is used to replicate a previously translated text or audio into sign language, using an AI model to refine the necessary movements.

An embodiment provides a software system capable of reading an audio file or a transcript and converting it into a sequence of sign language movements. A 3D or 2D avatar animation may be generated from the sequence of sign language movements in a primary window or in a secondary window on a user's computing device (or in a virtual reality or augmented reality space) using accelerated graphical APIs To make movements appear more natural, the sequence of gestures/movements may be generated through an AI model, or a combination of natural language analysis and an AI model, to smooth out any possible transition across the gestures and adapt it to the viewing condition.

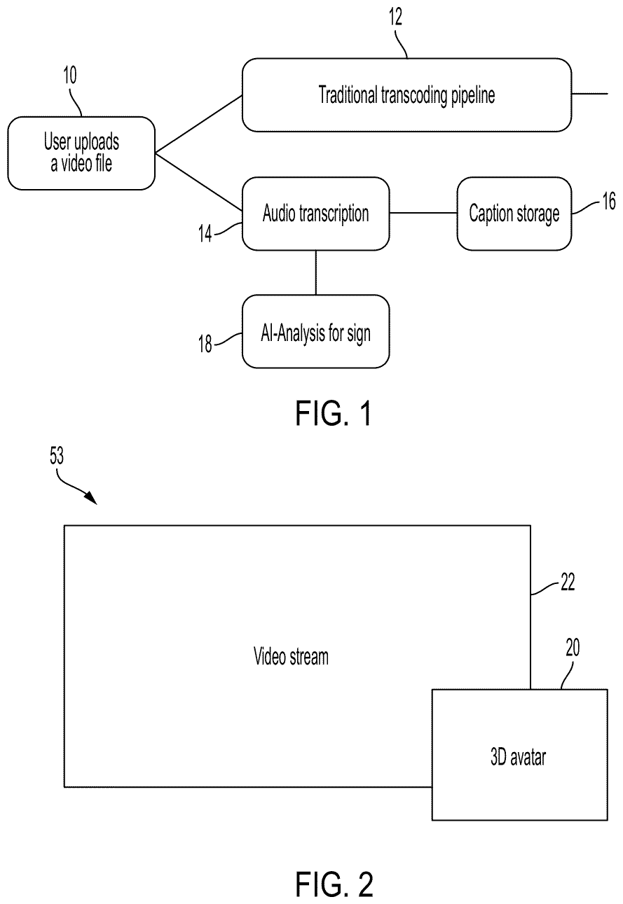

Referring to FIGS. 1-5, a user may upload a video file in step 10 (e.g., from user computer 52 to server(s) 50 over the network 58). From uploaded video file, a traditional video transcoding pipeline 12 is present on the server(s) 50. In a parallel computing path to the transcoding pipeline, the server(s) 50 may generate an audio transcription 14 from the spoken audio in the video file. This transcript may be used for captions (sent to caption storage in step 16) and may also be used to generate the sequence of sign language gesture/movement instructions in step 18.

The sequence of sign language instructions may be generated during the processing of the primary audio and video streams 12, and possibly after the audio-to-text transcription 14. In an embodiment the sign langue instructions include both word-for-word translations into American Sign Language (ASL) along with the associated ASL grammar, including sign order. See, for example, Rotem Shalev-Arkushin, et al., Ham2Pose: Animating Sign Language Notation into Pose Sequences (Apr. 1, 2023; cite as arXiv: 2211.13613v2) the disclosure of which is incorporated herein by reference. See, also, github.com/google/mediapipe/blob/master/docs/solutions/holistic.md (“MediaPipe Holistic.” Mar. 1, 2023) the disclosure of which is also incorporated herein by reference. The sign language instructions may be transmitted (for example, over the network 58 from the server(s) 50 to an end-user's computing device 52, 30, 46) with the encoded video and audio files as additional metadata.

Once the sequence of sign language gestures/movement insturctions is generated, it is used to drive a 3D avatar and displayed on-demand in a secondary window 20 alongside the main video window 22 of a video player operating on an end-user's computing device display 53, 34, 44. The user may select further customization options, such as language or avatar model.

Among the innovative features, this system/method allows the video creator to avoid creating or preparing subtitles and would make videos more accessible. Additionally, the use of AI would generate finely translated sequences that would consistently improve on the computer generated movements. Finally, the 3D avatar selection could be user-made, making the viewer more at ease watching the video.

In an embodiment, the program or application on the end-user's computing device 52, 30, 46 does not use a secondary video stream or pre-recorded videos for the secondary avatar animation view, but generates the 3D model in real time (or near real-time), using accelerated graphical APIs, including, but not limited to, browser canvas APIs, WebGL calls, Vulkan surfaces, and DirectX or Metal GPU access. See, Ada Rose Cannon and Brandel Zachernuk, Introducing Natural Input for WebXR in Apple Vision Pro (Mar. 9, 2024), the disclosure of which is incorporated herein by reference. See also, webglfundamentals.org which is a WebGL tutorial site including a set of articles that teach WebGL from basic principles, the disclosures of which are incorporated herein by reference. The server(s) 50 only need to transmit the sign language gesture/movement instructions, with or without timing and synchronization, along with the video stream to the user's computing device 52, 30, 46, while the browser (or video player software) of the user's computing device displays the animated avatar as a sequence of animations according to the instructions using the accelerated graphical APIs, thus conserving substantial processing capacity as compared to displaying a separate video stream animation for the avatar.

The synchronization between the video player and the secondary animated avatar may happen through various synchronization mechanisms. It could be a custom solution or a standard signaling, such as Timing Object-(www.w3. org/community/webtiming/) or WebSockets data packs. The protocol for avatar animation could be plain text format, such as JSON or XML, or use the WebVTT protocol for text tracks.

In an embodiment, the secondary view may be generated for a live-stream video as well, where such associated processing occurs on-the-fly after auto captioning, for example.

In an embodiment, the avatar selection is designed to be completely creator and/or user customizable. The idea is that a viewer or creator may upload an avatar in a well known 3D format, such as VRM (vrm.dev/en/vrm/vrm_about.html) and use it as base for the avatar movements. The VRM file format includes a list of parameters and values used to describe a 3D scene with a humanoid avatar, including a list of textures, meshes, materials, as well as armature information. This format is widely used in the VTube style of videos and has a wide range of application support and creator adoption.

Extending the aforementioned concept, in an embodiment, a creator may upload a set of avatars on a per-app basis and let users pick which one to use: for example an anime TV series could have characters from that series to be selectable avatars for the ASL window.

In an embodiment, the displayed avatar is a 2D avatar display.

In an embodiment, the avatar is a cut-out picture, video, or stream with a transparent or color-masked background.

In an embodiment, the displayed avatar is not displayed in a secondary window 20; rather, the avatar is overlayed or otherwise merged into, integrated into or generated with the video display so that the avatar appears part of the main video display.

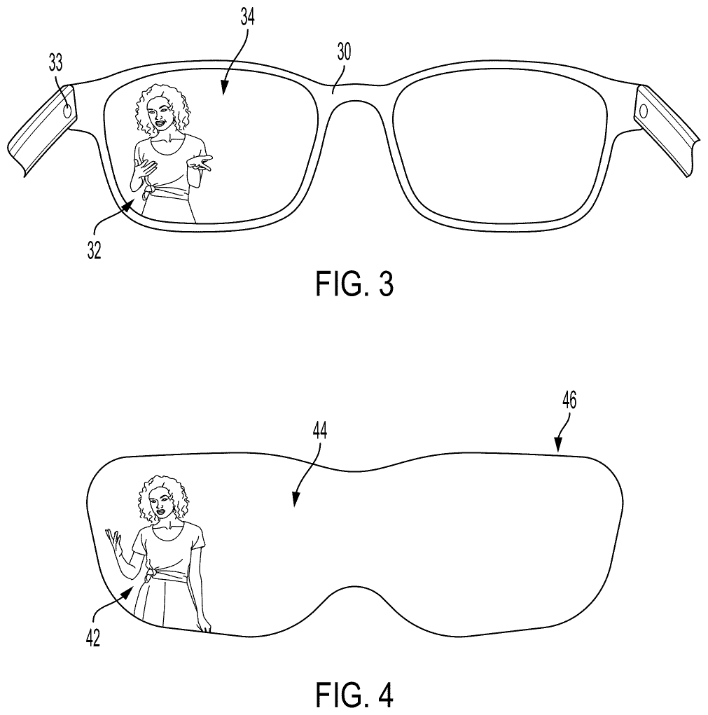

FIG. 3 shows an embodiment of the current disclosure in which an avatar 32 as disclosed herein is projected or otherwise displayed in a display portion 34 of an augmented reality display device 30, such as augmented reality glasses. One mode of operation for the augmented reality display device 30 (or any of the end-user computing devices 52, 30, 46) may be a stand-alone mode (e.g., not necessarily utilizing the server(s) 50). For example, the embodiment of FIG. 3 need only receive an audio input from the user's surroundings (e.g., from an integrated mic 33) with the augmented reality glasses and the processes and systems disclosed herein converts the speech received in the audio input into sign language gestures of the avatar 32 in real time or near real time as disclosed herein for display in the device's display portion 34. For example, if a user is speaking with another person while wearing the glasses 30, the audio input would include the other person's speech and the glasses 30 would convert the other person's speech in real time or near real time into sign language gestures of the displayed avatar 32.

FIG. 4 shows an embodiment of the current disclosure in which an avatar 42 as disclosed herein is incorporated into or otherwise displayed with the display 44 of a virtual reality display device, such as virtual reality goggles 46.

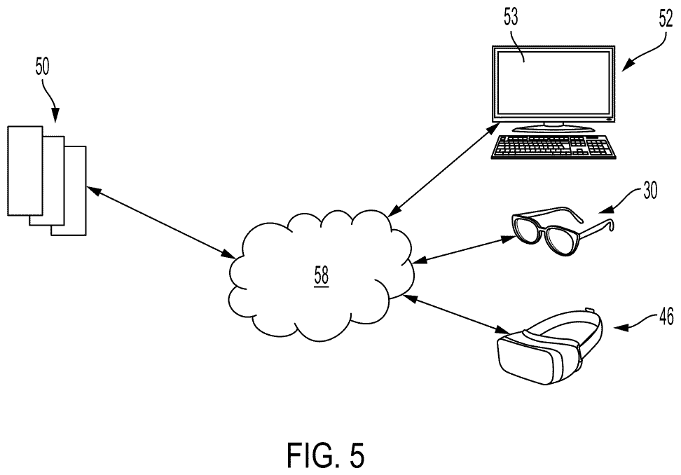

FIG. 5 provides an exemplary system diagram for implementing various embodiments disclosed herein. One or more servers 50 are connected to various computing devices (such as user computer 52 having a display 53, mobile computing device operating as an augmented reality display device 30, virtual reality display device 46 and the like) via data and network connections over a computer network 58 such as the Internet.

In general, the routines executed to implement the embodiments of the disclosure (for example, on server(s) 50 and/or on user devices 52, 30, 46), whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

As disclosed herein, certain software programs may be implemented in the form of an Application Programming Interface. APIs are programs for allowing two or more other computer programs or computer components to communicate with each other. Video acceleration APIs, for example, are APIs that allow certain software applications to use hardware video acceleration capabilities, such as those typically provided by a computer's graphical processing unit (GPU).

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a communication network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method for providing a sign-language avatar video for a primary video, comprising:
providing a video and a transcription of spoken audio from the video;
converting the transcription into a sequence of sign language instructions including one or both of gesture or movement instructions associated with word-for-word translation of the transcription into sign language and any associated sign language grammar, including sign order;
transmitting the video and sign language instructions to a user's computing device;
displaying the video by the user's computing device in a primary video window;
generating an avatar animation from the sign language instructions in the primary window or in a secondary window by the user's computing device using accelerated graphical APIs.

2. The method of claim 1, wherein the sequence of sign language instructions is generated by an AI model.

3. The method of claim 1, wherein the sequence of sign language instructions is generated by static conversion or translation.

4. The method of claim 1, wherein the avatar animation is on a 3D humanoid model.

5. The method of claim 1, wherein an avatar used in the avatar animation is customizable on the user's computing device.

6. The method of claim 5, wherein the user's computing device provides the user with a selection of available avatars from which to select from.

7. The method of claim 1, wherein an animation format for the avatar animation is based on a list of qualifying properties that describe a 3D scene and a humanoid avatar, including textures, meshes, materials, expressions, and armature.

8. The method of claim 1, wherein:
the video is processed on transcoding pipeline of a server; and
the converting step is performed on a parallel computing path to the transcoding pipeline.

9. A method for providing a sign-language avatar video for a primary video, comprising:
receiving on a user's computing device a primary video and secondary sign-language instructions associated with spoken audio in the primary video, the secondary sign-language instructions including one or both of gesture or movement instructions;
displaying the primary video on the user's computing device in a primary video window;
generating an avatar animation from the secondary sign-language instructions in either the primary video window or in a secondary window on the user's computing device using GPU processing calls.

10. A method for providing a sign-language avatar in a display, comprising:
receiving on a user's computing device or system an audio input;
converting speech in the audio input into a transcription of speech;
converting the transcription into a sequence of sign language instructions, the sign-language instructions including one or both of gesture or movement instructions associated with word-for-word translation of the transcription into sign language and any associated sign language grammar, including sign order; and
generating an animation from the sequence of sign-language instructions in a display portion of the user's computing device.

11. The method of claim 10, wherein the animation is generated using accelerated graphical APIs.

12. The method of claim 10, wherein the sequence of sign language instructions is generated by an AI model.

13. The method of claim 10, wherein the animation is either a 3D humanoid model or a 2D humanoid model.

14. The method of claim 13, wherein the animation is an avatar animation, which is customizable on at least one of the user's computing device or on a video-creator's configuration options.

15. The method of claim 14, wherein the avatar animation is customizable on the user's computing device, which provides a user with a selection of available avatars from which to select from.

16. The method of claim 10, wherein the audio input is extracted from a video input.

17. The method of claim 16, wherein the steps occur in real time or near real time.

18. The method of claim 10, wherein the steps occur in real time or near real time.

19. The method of claim 10, wherein the user's computing device or system comprises an augmented reality device.

20. The method of claim 10, wherein the user's computing device or system comprises a virtual reality device.

21. One or more non-transitory memory devices including computer instructions for controlling one or more computer processors to perform the steps of:
receiving on a user's computing device a primary video and secondary sign-language instructions associated with spoken audio in the primary video, the secondary sign-language instructions including one or both of gesture or movement instructions;
displaying the primary video on the user's computing device in a primary video window;
generating an avatar animation from the secondary sign-language instructions in either the primary video window or in a secondary window on the user's computing device using GPU processing calls.

22. One or more non-transitory memory devices including computer instructions for controlling one or more computer processors to perform the steps of:
receiving on a user's computing device or system an audio input;
converting speech in the audio input into a transcription of speech;
converting the transcription into a sequence of sign language instructions, the sign-language instructions including one or both of gesture or movement instructions; and
generating an animation from the sequence of sign-language instructions in a display portion of the user's computing device.

23. The one or more non-transitory memory devices of claim 22, wherein the animation is generated using accelerated graphical APIs.

24. The one or more non-transitory memory devices of claim 22, wherein the sequence of sign language instructions is generated by an AI model.

25. The one or more non-transitory memory devices of claim 22, wherein the animation is either a 3D humanoid model or a 2D humanoid model.

26. The one or more non-transitory memory devices of claim 25, wherein the animation is an avatar animation, which is customizable on the user's computing device or system.

27. The one or more non-transitory memory devices of claim 26, wherein the avatar animation is customizable on the user's computing device, which provides a user with a selection of available avatars from which to select from.

28. The one or more non-transitory memory devices of claim 22, wherein the audio input is extracted from a video input.

29. The one or more non-transitory memory devices of claim 22, wherein the processing steps occur in real time or near real time.
